(19) United States
(12) Patent Application Publication
(10) Pub. No.: US 2002/0144015 A1
(43) Pub. Date: Oct. 3, 2002

(54) Method and apparatus to implement a state machine

(76) Inventor: Victor B. Lortz, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/823,216

(22) Filed: Mar. 30, 2001

(51) Int. Cl. G06F 9/46; G06F 9/44; G06F 15/163; G06F 9/54; G06F 9/00

(52) U.S. Cl. 709/318; 709/315

(57) ABSTRACT

A method includes identifying a plurality of states and associated state classes to a state machine, identifying a plurality of events and associated state transitions to the state machine, and the state machine creating state objects and a transition map according to the plurality of states and events.

### COPYRIGHT NOTICE

A portion of the disclosure of this patent document contains material which is subject to copyright protection. The copyright owner has no objection to the facsimile reproduction by anyone of the patent document or disclosure as it appears in the Patent and Trademark Office patent file or records, but otherwise reserves all copyright rights whatsoever. The following notice applies to the software and data as described below and in the drawings hereto:

Copyright © 2001, Intel Corporation, All Rights Reserved.

### FIELD

The invention relates to the field of state machines, and, more particularly, to the definition of state machines.

### BACKGROUND

State machines have long been used to reduce software complexity in applications such as networking or process control, where processor-based devices must operate and respond to events and data conditions in a context-sensitive way. A state machine may comprise a plurality of states, each comprising a logic by which the state machine may operate. At any given moment, the state machine may operate in one of the plurality of states. This one state may be referred to as the current state. In response to events (external or internal signals or data conditions) a state machine may change its current state. The events/rules which result in a change of state are collectively referred to as the transition map for the state machine.

Conventional approaches to state machine design include the use of preconfigured conditional statements (switch statements, if-then statements, and so on) which determine, at compile time, the logic and transition map for a state machine. These conventional approaches also determine, at compile time, the logic comprised by each state. An approach to state machine design which determined the state machine logic, state logic, and transition map of a state machine, at run time, would be more flexible and would encourage the rapid implementation of a variety of state machines.

### FIGURES

The invention may be better understood with reference to the following figures in light of the accompanying description. The present invention, however, is limited only by the scope of the claims at the concluding portion of the specification.

FIG. 1 shows an embodiment of a state machine in accordance with the present invention.

FIG. 2 shows an embodiment of instructions in accordance with the present invention.

FIG. 3 shows an embodiment of instructions and data in accordance with the present invention.

FIG. 4 shows an embodiment of a class hierarchy in accordance with the present invention.

FIG. 5 shows a system embodiment according to the present invention.

### DESCRIPTION

In the following description, references to “one embodiment” or “an embodiment” do not necessarily refer to the same embodiment, although they may. Various operations of the description below and the claims are described in terms of software, e.g. instructions executed by a processor, either a general purpose processor, or a more task-specific processor such as an embedded processor or digital signal processor. The various operations may of course be carried out by software, hardware, firmware, or a combination thereof.

FIG. 1 shows a state machine embodiment 100 in accordance with the present invention. The state machine 100 comprises three states: state A, state B, and state C.

Each state may comprise logic to cause a processing system to operate in a certain fashion. For example, each state may comprise rules, in the form of instructions to a processor, for manipulating input data to produce a certain output. The state machine 100 further comprises transition rules for changing states. Thus, a change is made from state A to state B when event 1 occurs. Event 1 may comprise changes in data values, or the occurrence of stimuli such as a mouse click, receipt of data from an external source such as a peripheral or network device, and so on. A state change occurs from state B to state C when event 2 occurs. The occurrence of event 3 results in a change from state C to state A. A collection of the rules for changing states in a state machine may be referred to as the transition map for the state machine.

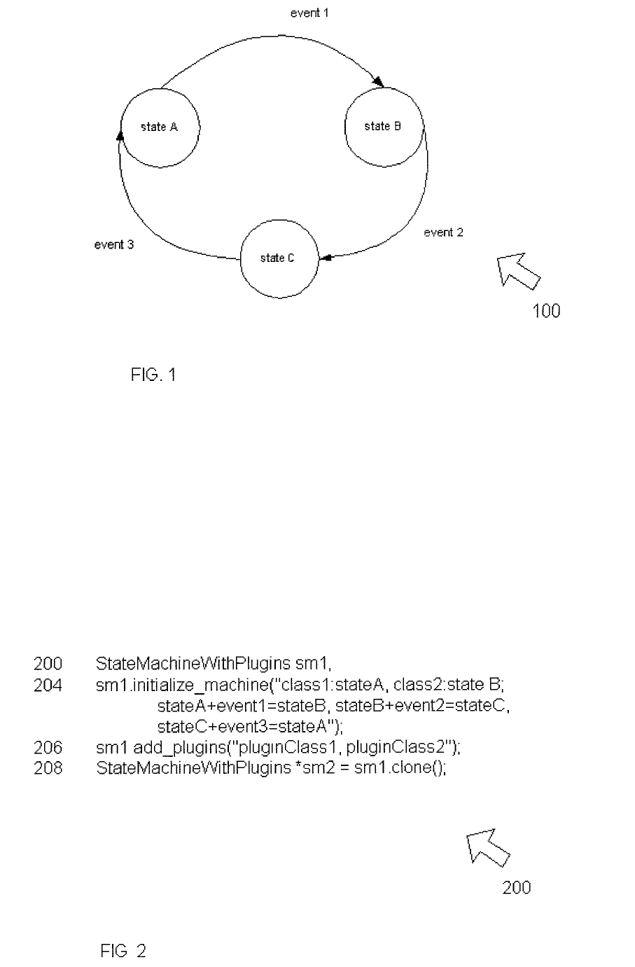

FIG. 2 shows an embodiment 200 of high-level software instructions in accordance with the present invention. Instructions 200 are rendered in the C++ programming language, although of course other computer languages could be employed. At 202 a first state machine object sm1 is declared. The object includes instructions and data for implementing an embodiment of a state machine in accordance with the present invention. At 204 a call is made to the state machine method initialize_machine. A specification of the states and transition map are passed to the initialize_machine method. The specification string in this embodiment implements the state machine embodiment of FIG. 1, having three states A, B, and C, and corresponding transition rules. The specification is made in the form of a string, although of course other data arrangements could also provide the specification. The following substring of the specification string provides the declaration of the states of the state machine, and associates with each state an implementing class.

“class1:stateA, class2:state B, class3:state C;”

According to this specification, the logic of state A is implemented by class1; state B by class2; and state C by class3. Each of these classes may comprise instructions and/or data for performing specific processing. In one embodiment, each state logic is “stateless”, e.g. a single instance of the state class may be employed by multiple state machines.

The following substring of the specification string provides the declaration of the transition map for the state machine.

“stateA+event1=stateB, stateB+event2=stateC, stateC+event3=stateA”

Thus, occurrence of event 1 at state A results in a change of the current state to state B. Occurrence of event 2 at state B results in a change of the current state to state C. Occurrence of event 3 at state C results in a change of the current state to state A.

In one embodiment, a state machine class provides functionality to apply the rules of the transition map to change the current state of the state machine. Furthermore, the state machine class may comprise logic to invoke the logic of the current state. In one embodiment, the logic of the current state is invoked upon the occurrence of a state change. In other embodiments, the logic of the current state may be invoked at different (possibly periodic) times.

In one embodiment, the functionality of the state machine class may be enhanced by way of “plug-ins”, e.g. objects which implement functionality not found in the state machine class, and which may interact with the state machine class via a predetermined interface. For example, a plug-in may be employed to provide events, such as email messages, to the state machine in the form of state transition events. The plug-in may monitor the arrival of an email message from the email application. The email application, of course, is not designed to interact with the state machine, nor is the state machine designed to interact with the email application. However, the plug-in may be designed to interact with both. Thus, the plug-in may retrieve the email message from the email application and provide it to the state machine in the form of a state transition event. Of course, plug-ins are not limited to providing events to the state machine, and may be used for other purposes (e.g. to implement state-specific functionality) as well.

At 206 the plug-in objects for the state machine class are specified by way of the add_plugins method call. A plug-in specification string is passed to the call:

“pluginClass1, plugClass2”

Thus the state machine sm1 will be enhanced with the functionality of two classes; pluginClass1 and pluginClass2.

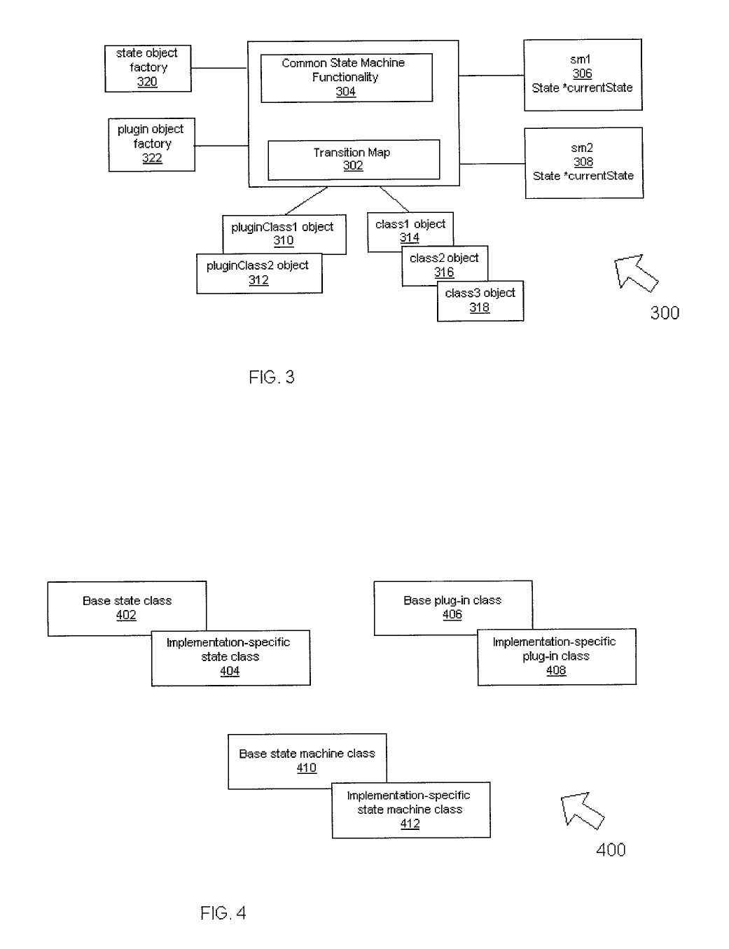

At 208, a second state machine instance is created by cloning the first. Cloning is a well-known technique in object-oriented software design. An advantage of cloning over conventional object construction (for example, by way of the C++ “new” operator) is that post-object creation settings are provided to the clone. Thus, by cloning, the state definitions, transition map, and plug-in settings applied by way of the initialize_machine and add_plugins calls may be applied to the cloned object. As will be described more fully in conjunction with FIG. 3, each state machine object (e.g. class instance) may comprise a small amount of storage space, and multiple objects may share common functionality and data of the state machine class.

While specific character sequences have been provided for the classes, objects, data, and method calls of FIG. 2, the invention is of course not limited in this regard. Features of the present invention may be provided without necessarily invoking the particular illustrated methods in the order illustrated. In other words, software is highly adaptable and the operations of the present invention may be provided using more or fewer methods, with various parameters, using various classes and objects which may not correspond precisely with those illustrated. Only the appended claims define the scope of the present invention.

In one embodiment, the state machine employs “factory” classes to create the state and plug-in objects. In this manner, the state machine class need not comprise logic concerning the details of creating the state and plug-in objects. In one embodiment, a reference to the state factory object is passed to initialize_machine, and a reference to the plug-in factory object is passed to add_plugins.

FIG. 3 shows an embodiment 300 of software (instructions and data) in accordance with the present invention. Two state machine objects 306 and 308 are created by instantiating the state machine class. A single instance of shared state machine functionality 304 is shared by both objects. Each object 306 and 308 comprises data to identify the current state of the state machine for that instance. In one embodiment the instance of the state machine may comprise a current state identifier and an instance of each plug-in object. The shared functionality 304 comprises the transition map 302 for the state machine objects 306 and 308. The shared functionality 304 may invoke, on behalf of the objects 306 and 308, instances of the state classes 314, 316, and 318 which were specified in the call to initialize_machine. When such state instances (objects) comprise “stateless” logic, each state machine object 306 and 308 may share use of the same state objects. Stateless logic refers to logic which operates independently of prior operations of the logic. When state instances are not stateless (e.g. not shareable), each state machine object may have its own associated list of state objects.

The definition of the state machine class may be parameterized (for example, using C++ templates). The parameterized state machine may be compiled to operate with state and plug-in classes which are extensions of base state and plug-in classes. Thus, the base state machine class, base state class, and base plug-in class define a framework by which software designers may rapidly implement custom state machines. Further, plug-in classes may employ state class extensions without resorting to run-time type casting of the current state object pointer. This may result in performance improvements in many implementations.

FIG. 4 shows a class hierarchy embodiment 400 in accordance with the present invention. A base state machine class 410 of the development framework is extended to create an implementation-specific state machine class 412. The base state class 402 of the framework is extended to create the implementation-specific state classes 404, and the base plug-in class 406 of the framework is extended to create the implementation-specific plug-in classes 408. The implementation-specific class 412 is designed to operate with one or more implementation-specific state classes 404 and optionally with one or more implementation-specific plug-in classes 408. In one embodiment, a software developer provides factory classes to create and initialize implementation-specific state and plug-in objects with which an implementation-specific state machine object may interact.

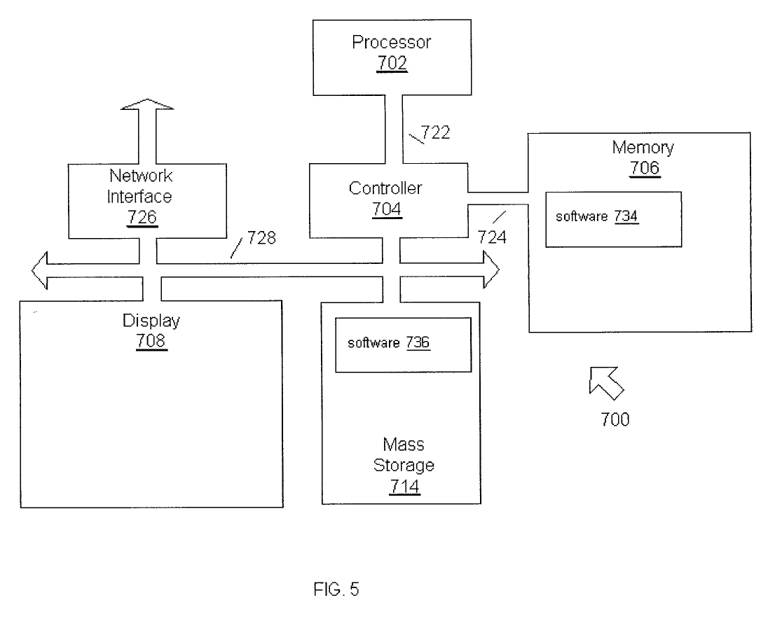

FIG. 5 shows a system embodiment 700 in accordance with the present invention. Embodiment 700 comprises a processor 702 coupled to a controller 704 by way of a processor bus 722, commonly referred to as a front side bus. Bus controller 704 is coupled to memory 706 via memory bus 724. Bus controller 704 is also coupled to various peripheral devices such as mass storage 714, network interface 726, and display 708 via I/O bus 728. Network interface 726 provides apparatus 700 with access to networks such as the Internet or corporate intranets. Memory 706 stores a software embodiment 734 to perform operations to implement a state machine as herein described and in accordance with the present invention. Software 734 may be stored in memory 706 in a form suitable for access and execution by processor 702. An archived loadable form 736 of software 734 may be stored by mass storage 714 for loading into memory 706 for execution by processor 702. Mass storage 714 may comprise any form of non-volatile memory including hard drives, CD ROM drives, ZIP drives, diskettes, and so on.

Memory 706 is typically a form of random access memory (RAM) such as a DRAM, flash memory, SDRAM, and so on. Memory 706 supplies the instructions of software 734 stored therein to processor 702 for execution. Execution of software embodiment 734 by processor 702 may result in a process to perform operations to implement a state machine, as herein described and in accordance with the present invention.

Of course, those skilled in the art will appreciate that other embodiments could comprise different combinations of software, hardware, and firmware than those illustrated to carry out the operations of the present invention as well.

While certain features of the invention have been illustrated as described herein, many modifications, substitutions, changes and equivalents will now occur to those skilled in the art. It is, therefor, to be understood that the appended claims are intended to cover all such embodiments and changes as fall within the true spirit of the invention.

What is claimed is:

1. A method comprising:
identifying a plurality of states and associated state classes to a state machine;
identifying a plurality of events and associated state transitions to the state machine; and
the state machine creating state objects and a transition map according to the plurality of states and events.

2. The method of claim 1 further comprising:
identifying at least one plug-in class to the state machine, the plug-in class configured to monitor predetermined events.

3. The method of claim 2 further comprising:
the state machine creating a plug-in object according to the plug-in class, the plug-in object interacting with the transition map to cause state transitions.

4. The method of claim 1 further comprising:
identifying at least one state factory to the state machine, the state machine invoking the state factory to create the state objects.

5. The method of claim 1 further comprising:
identifying at least one plug-in factory to the state machine, the state machine invoking the plug-in factory to create the plug-in objects.

6. A method comprising:
extending a base state class to create at least one extended state classes;
configuring a base state machine class to operate with the extended state classes; and
associating the extended state class with a state.

7. The method of claim 6 further comprising:
extending a base plug-in class to create at least one extended plug-in classes;
configuring the base state machine class to operate with the extended plug-in classes; and
associating an event monitored by the extended plug-in class with a state transition.

8. The method of claim 7 in which the base state machine class is configured to cooperate with a state factory class to create state objects according to the extended state classes.

9. The method of claim 7 in which the base state machine class is configured to cooperate with a plug-in factory class to create plug-in objects according to the extended plug-in classes.

10. An article comprising:
a machine-readable medium comprising instructions which, when executed by a processor, result in:
identifying a plurality of states and associated state classes to a state machine;
identifying a plurality of events and associated state transitions to the state machine; and
the state machine creating state objects and a transition map according to the plurality of states and events.

11. The article of claim 10 further comprising instructions which, when executed by the processor, result in:
identifying at least one plug-in class to the state machine, the plug-in class configured to monitor predetermined events.

12. The article of claim 11 further comprising instructions which, when executed by the processor, result in:
the state machine creating a plug-in object according to the plug-in class, the plug-in object interacting with the transition map to cause state transitions.

13. The article of claim 10 further comprising instructions which, when executed by the processor, result in:
identifying at least one state factory to the state machine, the state machine invoking the state factory to create the state objects.

14. The article of claim 10 further comprising instructions which, when executed by the processor, result in:
identifying at least one plug-in factory to the state machine, the state machine invoking the plug-in factory to create the plug-in objects.

15. A system comprising:
a processor; and
a machine-readable medium comprising instructions which, when executed by the processor, result in;
identifying a plurality of states and associated state classes to a state machine;
identifying a plurality of events and associated state transitions to the state machine; and
the state machine creating state objects and a transition map according to the plurality of states and events.

16. The system of claim 15 further comprising instructions which, when executed by the processor, result in:
identifying at least one plug-in class to the state machine, the plug-in class configured to monitor predetermined events.

17. The system of claim 16 further comprising instructions which, when executed by the processor, result in:
the state machine creating a plug-in object according to the plug-in class, the plug-in object interacting with the transition map to cause state transitions.

18. The system of claim 15 further comprising instructions which, when executed by the processor, result in:
identifying at least one state factory to the state machine, the state machine invoking the state factory to create the state objects.

19. The system of claim 15 further comprising instructions which, when executed by the processor, result in:
identifying at least one plug-in factory to the state machine, the state machine invoking the plug-in factory to create the plug-in objects.
